(19) United States
(12) Patent Application Publication
(10) Pub. No.: US 2008/0243802 A1
(43) Pub. Date: Oct. 2, 2008

(54) METHOD AND APPARATUS FOR SEARCHING FOR CONTENT USING METADATA BASED CATEGORIES, AND RECORDING MEDIUM THEREOF

(75) Inventor: Sang-jun HAN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/850,694

(22) Filed: Sep. 6, 2007

(30) Foreign Application Priority Data
Mar. 27, 2007 (KR) 10-2007-0030054

(51) Int. Cl. G06F 17/30

(52) U.S. Cl. 707/4; 707/E17.108

(57) ABSTRACT

A method and apparatus for searching for content using metadata based categories, and a computer readable recording medium storing a computer program for executing the method are provided. The method includes displaying at least one category, displaying a sub-category list of a first category selected from among the displayed categories, displaying a sub-category, which is selected based on the sub-category list of the first category, in a field connected to the first category, and displaying a content list connected to the sub-category displayed in the field.

### CROSS-REFERENCE TO RELATED PATENT APPLICATION

This application claims priority from Korean Patent Application No. 10-2007-0030054, filed on Mar. 27, 2007 in the Korean Intellectual Property Office, the disclosure of which is incorporated herein in its entirety by reference.

### BACKGROUND OF THE INVENTION

1. Field of the Invention

The present invention relates to a search of content stored in a digital storage device, and more particularly, to a method and apparatus for searching for content using metadata based categories, and a computer readable recording medium storing a computer program for executing the method.

2. Description of the Related Art

Digital storage devices are hard disks, MP3 players, Portable Multimedia Players (PMPs), Personal Video Recorders (PVRs), and so on. Such a digital storage device can be defined as a digital recording and reproducing device.

The large capacity of digital storage devices and the development of compression technology have resulted in a considerable increase in the amount of content which can be stored in a digital storage device. Due to the increase in the amount of content stored in a digital storage device, it is getting difficult to search for content desired by a user. This problem is more severe in digital storage devices, such as portable MP3 players and PMPs, in which, due to their small size, it is difficult to display data.

Accordingly, a method of searching for content using metadata based categories has been suggested for an efficient content search. A metadata based category is information used to classify metadata according to attributes and can be defined as a metadata category.

Metadata based categories can be defined as categories and sub-categories according to a search order. That is, categories are in the highest layer searched first, and sub-categories are in a lower layer than the categories. For example, actor, director, genre, sport, league, team, album, artist, player, and school can be set as categories, and actor name, director name, genre name, sport name, league name, team name, album name, artist name, player name, and school name can be respectively set as sub-categories of these categories.

However, the information which can be set as categories and the information which can be set as sub-categories can be defined as sub-categories and categories, respectively. For example, an “artist name” category is set as a sub-category of an “artist” category, and an “album” category can be set as a sub-category of the “artist name” category. In this case, the “artist” category becomes the highest category, and the “artist name” category and the “album” category become sub-categories of the “artist” category. In another case, the “artist name” category can be set as a category searched first, and the “album” category can be set in a lower layer of the “artist name” category. In this case, the “artist name” category becomes the highest category, and the “album” category becomes a sub-category of the “artist name” category.

Metadata of content is data for representing the content and can include, for example, content name, content amount, content creation date, title added to content, and information which can be defined as sub-categories.

Metadata based categories can be defined in a metadata field of a content file. The metadata field can be, for example, an Iterative Dichotomiser 3 (ID3) tag or an Exit tag of a Joint Photographic Experts Group (JPEG) file. For example, if a metadata based category is “artist,” “artist name” is extracted from tag information of a content file, and a sub-category list of the “artist” category can be created using the extracted “artist name.” The extracted artist name is metadata of content and a sub-category of the “artist” category. If an artist name is selected based on the sub-category list created as the extracted “artist name,” a content name connected to the artist name selected from the tag information of content is extracted, a content list is created using the extracted content name, and content to be reproduced is selected based on the created content list.

However, in a related art content search method using metadata based categories, a search is performed according to a hierarchical search order set in advance for each digital storage device. For example, when a search order of a digital storage device is set as illustrated in FIG. 1, if a content search is requested, a metadata based category list including a category 1 and a category 2 is displayed on a first screen 200 illustrated in FIG. 2. The category 1 and the category 2 displayed on the first screen 200 are in the highest layer.

If the category 1 is selected while the first screen 200 is being displayed, a second screen 210 illustrated in FIG. 2 is displayed. The second screen 210 is a screen on which a sub-category 1 and a sub-category 2 are displayed. The sub-category 1 and the sub-category 2 are sub-categories of the category 1. If the sub-category 1 is selected from the second screen 210, a content list is displayed on a third screen 220 illustrated in FIG. 2. If content 1 is selected from the third screen 220, the content 1 is reproduced.

As described above, since the related art content search method using metadata based categories allows a user to access desired content according to a hierarchical search order set in advance, the user cannot change the search order.

For example, if the category 1 is “ballad,” which is a kind of genre, and the sub-category 1 is “artist name 1” in FIGS. 1 and 2, the user can access the content 1 only if the user accesses “ballad” and “artist name 1” in the hierarchical order, but the user cannot access the content 1 by directly using “artist name 1” corresponding to the sub-category 1. Thus, the related art content search method using metadata based categories has a low content search efficiency. This problem may be clearer when a sub-category of a metadata based category is set with a plurality of layers (sub-category 1 and sub-category 1′) as in the category 2 illustrated in FIG. 1.

In addition, according to the related art content search method using metadata based categories, it is difficult to determine an entire search condition of desired content after the user accesses the desired content. For example, it can be determined from the third screen 220 illustrated in FIG. 2 that the content 1 has been accessed through the sub-category 1. However, it can not be known from the third screen 220 that the sub-category 1 is a sub-category of the category 1. This problem may also be clearer when a sub-category of a metadata based category is set with a plurality of layers (sub-category 1 and sub-category 1′) as in the category 2 illustrated in FIG. 1.

### SUMMARY OF THE INVENTION

The present invention provides a method and apparatus for searching for content using metadata based categories, by which a search condition of selected content can be easily determined, and a computer readable recording medium storing a computer program for executing the method.

The present invention also provides a method and apparatus for searching for content using metadata based categories, by which content can be searched in a search order desired by a user by providing independent selection rights to the metadata based categories available for the content search, and a computer readable recording medium storing a computer program for executing the method.

According to an aspect of the present invention, there is provided a method of searching for content using metadata based categories, the method comprising: displaying at least one category; displaying a sub-category list of a first category selected from among the displayed categories; displaying a sub-category, which is selected based on the sub-category list of the first category, in a field connected to the first category; and displaying a content list connected to the sub-category displayed in the field.

According to another aspect of the present invention, there is provided an apparatus for searching for content using metadata based categories, the apparatus comprising: an information input unit through which a user inputs information; a display unit which displays a selectable category list, a sub-category list of a selected category, a category list updated by a sub-category selected based on the sub-category list, and a content list based on the updated category list; a storage unit which stores at least one piece of content, metadata of the content, and metadata based category information of the content; and a controller which transmits screen information for a content search to the display unit by searching the storage unit according to the information input via the information input unit.

According to another aspect of the present invention, there is provided a computer readable recording medium storing a computer program for executing a method of searching for content using metadata based categories, the method comprising: displaying at least one category; displaying a sub-category list of a first category selected from among the displayed categories; displaying a sub-category, which is selected based on the sub-category list of the first category, in a field connected to the first category; and displaying a content list connected to the sub-category displayed in the field.

### BRIEF DESCRIPTION OF THE DRAWINGS

The above and other aspects of the present invention will become more apparent by describing in detail exemplary embodiments thereof with reference to the attached drawings in which:

FIG. 1 illustrates a correlation between metadata based categories and content defined in a related art digital storage device;

FIG. 2 illustrates search screens used in a related art content search method based on the correlation illustrated in FIG. 1;

FIG. 3 is a block diagram of a content search apparatus according to an exemplary embodiment of the present invention;

FIG. 4 illustrates screens displayed during a content search according to an exemplary embodiment of the present invention;

FIG. 5 illustrates screens displayed during a content search according to another exemplary embodiment of the present invention;

FIG. 6 illustrates screens displayed during a content search according to another exemplary embodiment of the present invention;

FIG. 7 is a flowchart of a content search method according to an exemplary embodiment of the present invention;

FIG. 8 is a flowchart of a content search method according to another exemplary embodiment of the present invention; and

FIG. 9 is a flowchart of a content search method according to another exemplary embodiment of the present invention.

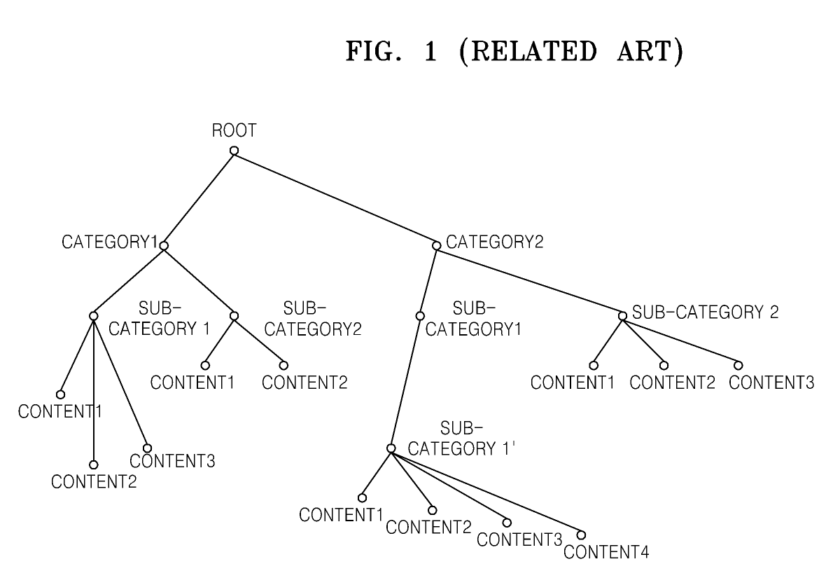

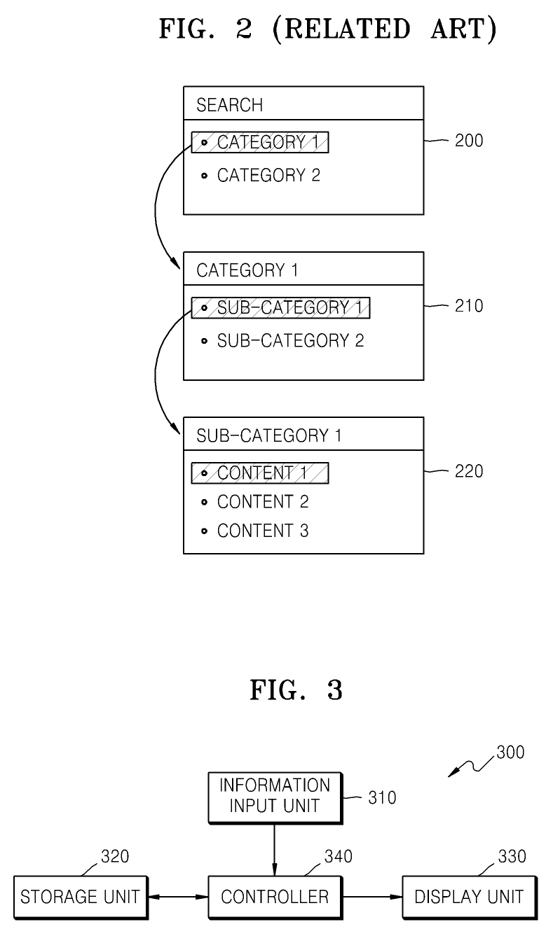

### DETAILED DESCRIPTION OF EXEMPLARY EMBODIMENTS OF THE INVENTION

The present invention will be described in detail by explaining exemplary embodiments of the invention with reference to the attached drawings.

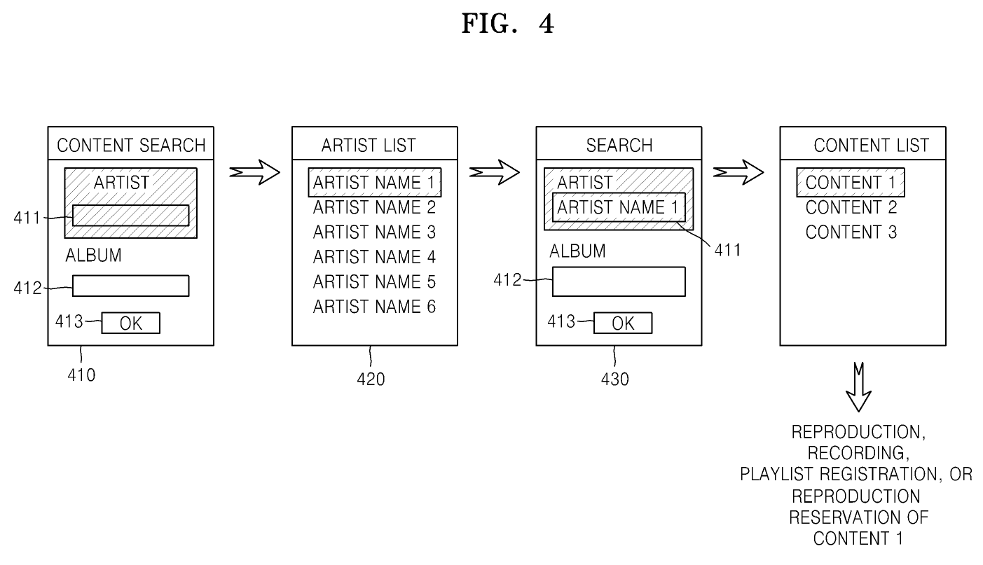

FIG. 3 is a block diagram of a content search apparatus according to an exemplary embodiment of the present invention. Referring to FIG. 3, a content search apparatus 300 includes an information input unit 310, a storage unit 320, a display unit 330, and a controller 340.

The information input unit 310 is a component through which a user can input information, and provides a function of selecting information that the user desires to input. In particular, the information input unit 310 provides a function of selecting information that the user desires to input, based on information displayed by the display unit 330.

For example, in the case of MP3 players and PMPs, a selection key, direction keys, and a touch pad can be used as the information input unit 310. In the case of Personal Digital Assistants (PDAs), a touch pad, number keys, and character keys can be used as the information input unit 310. In the case of Personal Computers (PCs), a keyboard, a mouse, and a touch pad can be used as the information input unit 3 10. The information input unit 310 may be configured in order for the user to select desired information by receiving the user's voice using voice recognition technology or receiving the user's motion using motion recognition technology.

The storage unit 320 stores at least one piece of content, metadata of the content, and metadata based category information used to search for the content. The metadata based category information stored in the storage unit 320 can be classified into categories and sub-categories and stored. The categories are information which can be accessed first in a content search, and the sub-categories are information which can be located in a lower layer of the accessed categories. For example, actor, director, genre, sport, league, team, album, artist, player, and school can be stored as categories, and actor name, director name, genre name, sport name, league name, team name, album name, artist name, player name, and school name can be respectively stored as sub-categories of these categories. The categories and the sub-categories stored in the storage unit 320 may have a hierarchical structure.

However, since the categories can be independently selected, the categories stored in the storage unit 320 do not have the hierarchical structure. That is, information classified as categories is stored in the storage unit 320 to have the same search order and may have a virtual hierarchical structure according to a search order selected by the user.

For example, when actor, director, genre, sport, league, team, album, artist, player, and school are stored in the storage unit 320 as categories having the same search order, if the user selects categories in the order of “genre,” “artist,” and “album,” the “artist” and the “album” become sub-categories of “genre,” and the “genre” becomes a category in the highest layer. Thus, metadata based categories having a virtual hierarchical structure in the order of “genre,” “genre name,” “artist,” “artist name,” “album,” and “album name” can be set. The metadata based category information having the virtual hierarchical structure is not stored in the storage unit 320. When the user selects only “artist” from among the categories, hierarchical metadata based categories can be set in the order of “artist” and “artist name.”

The storage unit 320 can also store a sub-category list and a content list for each category that are selectable based on metadata based categories. Each sub-category list and each content list can be created by the controller 340 and stored in the storage unit 320, based on the information input via the information input unit 310 and the metadata of content and the metadata based categories stored in the storage unit 320.

Each sub-category list and each content list stored in the storage unit 320 may differ according to selected categories and a selected order of categories. That is, according to how to combine the categories and sub-categories stored in the storage unit 320, a sub-category list and content list to be created may differ. For example, sub-category lists of “genre name” and “artist name” and content lists thereof in the case where categories having a virtual hierarchical structure are selected in the order of “genre,” “genre name,” “artist,” and “artist name” are different from sub-category lists of “artist name” and “genre name” and content lists thereof in the case where categories having a virtual hierarchical structure are selected in the order of “artist,” “artist name,” “genre,” and “genre name.” Each content list is a list for selecting content that the user desires to execute, and is determined according to a search condition selected by the user.

The storage unit 320 is an area in which data is stored in an electromagnetic pattern, and can be configured with Random Access Memory (RAM), a hard disk, a tape, or the like.

The display unit 330 can display a screen for a content search and selected content. The screen for a content search can include a screen of a selectable category list, a screen of a sub-category list of a selected category, a screen of a category list updated by a sub-category selected based on the sub-category list, and a screen of a content list based on the updated category list.

FIG. 4 illustrates screens displayed during a content search according to an exemplary embodiment of the present invention. The screen for a content search, which is displayed by the display unit 330, will now be described with reference to FIG. 4.

If a content search is requested from the information input unit 310, a first screen 410 is displayed by the display unit 330. The first screen 410 displays at least one category, and can be defined as a selectable category list screen, a content search screen, or a search screen. The selectable category list screen is based on information stored as categories in the storage unit 320. The selectable category list screen displays a list of categories which can be accessed first of all in the content search, i.e. a list of categories in the highest layer among the metadata based categories.

As shown in the first screen 410, the selectable category list screen can include fields 411 and 412 connected to categories and an OK button 413. The field 411 is connected to “artist” and is a region in which information regarding a sub-category selected based on a sub-category list of “artist” is displayed. The field 412 is connected to “album” and is a region in which information regarding a sub-category selected based on a sub-category list of “album” is displayed. The fields 411 and 412 can be defined as various User Interface (UI) patterns for representing a connection relationship between a category and a selected sub-category. The OK button 413 is a button used by the user to select that a content search condition has been selected, and can be a “confirm” button.

If highlighted “artist” is selected from the first screen 410, a second screen 420 is displayed by the display unit 330. The second screen 420 displays a sub-category list of a category selected from among the categories displayed on the first screen 410. Thus, the second screen 420 displays a sub-category list screen including “artist name 1” through “artist name 6.” Thus, “artist name 1” through “artist name 6” become sub-categories of the “artist” category.

If highlighted “artist name 1” is selected from the second screen 420, a category list screen updated due to “artist name 1” is displayed on the display unit 330. A third screen 430 is the updated category list screen. As shown in the first screen 410 and the third screen 430, the selectable category list screen and the updated category list screen have the same format. The third screen 430 that is the updated category list screen further displays the sub-category (“artist name 1”) selected due to the sub-category selection in the field 411. Information on the sub-category displayed in the field 411 may be a name of the selected sub-category, or an abbreviation or identification sign representing the selected sub-category.

Although “artist” is highlighted on the third screen 430, “album” may be highlighted. If the user selects the OK button 413 on the third screen 430, a fourth screen 440 is displayed by the display unit 330. The fourth screen 440 is a content list screen connected to the sub-category displayed in the field 411. If highlighted “content 1” is selected from the fourth screen 440, the controller 340 can control a reproduction function, a recording function, a playlist registering function, and a reproduction reservation function of “content 1” selected by the request of the user. The playlist is a list of content selected according to a user's taste, wherein each playlist can be generated as a separate file, which may include links or identification information related to the content in the list.

If the user requests to change the fourth screen 440 to a screen in an upper layer, i.e. a previous screen or the selectable category list screen, the controller 340 controls the display unit 330 to change the fourth screen 440 to the immediately previous selectable category list screen, i.e. the third screen 430 in the case of FIG. 4. Thus, the user can easily perceive a content search condition (or metadata based categories) related to the content list displayed on the fourth screen 440. If the user requests to change to a screen in an upper layer using the information input unit 310 when the second screen 420 is displayed by the display unit 330, the controller 340 controls the display unit 330 to change the second screen 420 to the first screen 410.

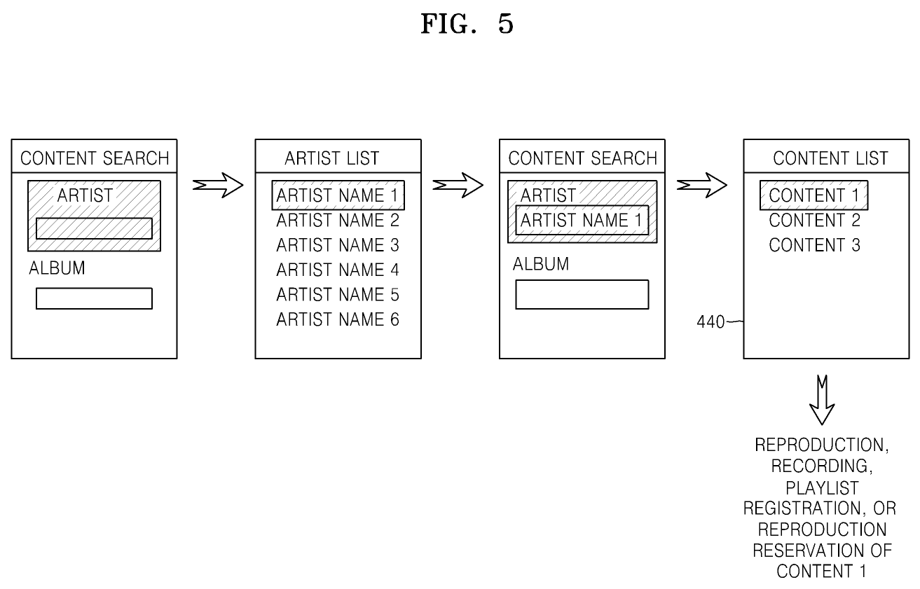

Meanwhile, the OK button 413 illustrated in FIG. 4 is not a definitely necessary component. In other words, the screens illustrated in FIG. 4 can be redefined without the OK button 413 as illustrated in FIG. 5. In addition, although the second screen 420 or the fourth screen 440 displayed by the display unit 330 can be changed to the first screen 410 or the third screen 430 according to the user's request, it can be implemented that the second screen 420 or the fourth screen 440 displayed by the display unit 330 is changed to the first screen 410 or the third screen 430 regardless of the user's request. As shown in FIG. 4, the second screen 420 and the fourth screen 440 have the same format, and the first screen 410 and the third screen 430 have formats different from the second screen 420 and the fourth screen 440.

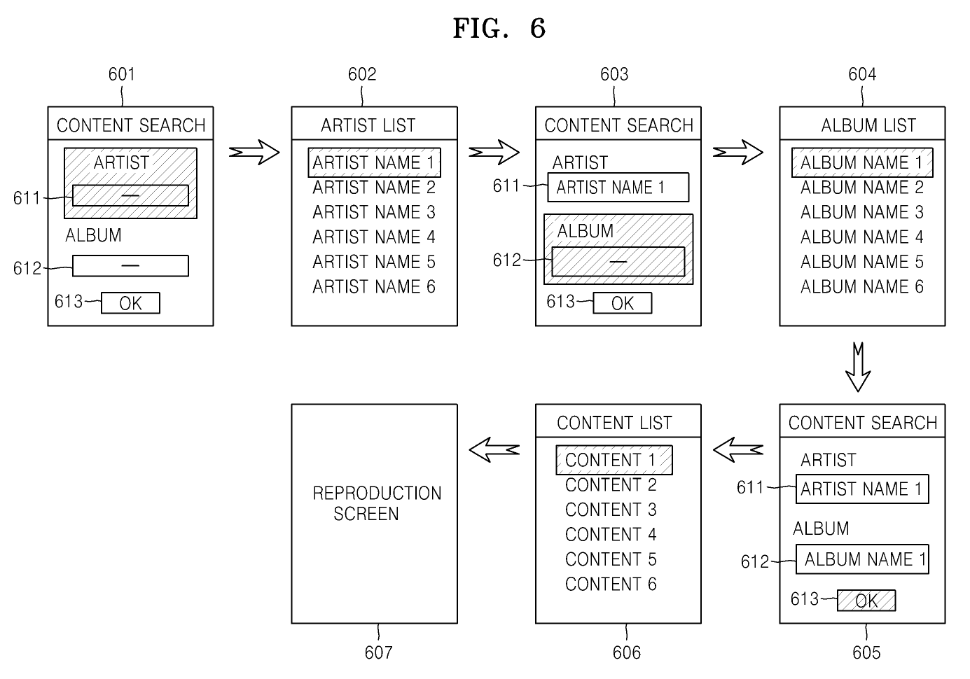

FIG. 6 illustrates screens displayed during a content search according to another exemplary embodiment of the present invention. Referring to FIG. 6, if “artist” is selected in a state where a selectable category list screen 601 including “artist” and “album” categories is displayed by the display unit 330, a sub-category list screen 602 of “artist” is displayed by the display unit 330.

If “artist name 1” is selected in a state where the sub-category list screen 602 is displayed, an updated category list screen 603 is displayed by the display unit 330. The updated category list screen 603 is a screen on which “artist name 1,” which is the selected sub-category, is displayed in a field 611 connected to the “artist” category.

If the “album” category is selected from the updated category list screen 603, a sub-category list screen 604 of the “album” category is displayed by the display unit 330. If “album name 1” is selected in a state where the sub-category list screen 604 of the “album” category is displayed, an updated category list screen 605 is displayed by the display unit 330. The updated category list screen 605 is a screen on which “artist name 1”, which is the previously selected sub-category, is displayed in the field 611 connected to the “artist” category, and “album name 1”, which is a currently selected sub-category, is displayed in a field 612 connected to the “album” category. The sub-category displayed in the field 611 and the sub-category displayed in the field 612 are connected to each other. Thus, the sub-category list screen 604 displays a sub-category list connected to “artist name 1.”

If an OK button 613 acting as the OK button 413 illustrated in FIG. 4 is selected from the updated category list screen 605, a content list screen 606 connected to both the sub-category displayed in the field 611 and the sub-category displayed in the field 612 is displayed by the display unit 330. If “content 1” is selected from the content list screen 606, the display unit 330 displays a reproduction screen 607 of the selected content.

When content is searched for as illustrated in FIG. 6, although “artist” and “album” are stored in the storage unit 320 to have the same search order, the “album” category is set as a sub-category of the “artist” category according to a search condition defined by the user. In this case, the user can perceive from the content search screen 605 by which search condition the content list has been found.

For convenience of description, FIGS. 4 through 6 illustrate cases where two categories are included in each selectable category list. However, if N selectable categories are stored in the storage unit 320, each selectable category list screen displays N categories. If a selectable category list screen including N categories is displayed, the user can select all the N categories or a portion of the N categories. In addition, in the category selection, a selection order is not determined in the order arranged in the selectable category list but by the user. In addition, if a system to which the present invention is applied is for audio only, the content illustrated in FIGS. 4 through 6 can be defined as tracks.

If the user wants to view metadata based categories (or search condition), which are a path related to the content list screen 606 being displayed, from the content list screen 606, the user can view a previous screen by inputting predetermined information using the information input unit 310. In this case, the user can see a search condition of a finally searched content list on a single screen, and if the user wants to search for a new category, the user can update the content list by additionally selecting the new category and filling information on a newly selected sub-category in a field connected to the new category.

If the user wants to cancel a category from among selected categories on a content search screen and simultaneously search for a new category, the user can receive a newly updated content list by erasing information on a sub-category displayed in a field connected to the category to be cancelled and filling information on a newly selected sub-category in a field connected to the new category.

As described above, according to an exemplary embodiment of the present invention, entire categories do not have to be searched in order to update a searched content list.

The display unit 330 can include a display module, such as Cathode Ray Tube (CRT), Liquid Crystal Display (LCD), or Organic Light Emitting Diode (OLED), or any other types produced to transfer information to users and visually output data to be transferred. The data provided through the display unit 330 can be represented by using a method comprising text, a Graphic User Interface (GUI) image, voice, or a motion of a device.

The controller 340 illustrated in FIG. 3 transmits screen information for a content search to the display unit 330 by searching the storage unit 320 according to information input via the information input unit 310. That is, if a category is selected from the first screen 410 illustrated in FIG. 4, the controller 340 searches for a sub-category list of the selected category from the storage unit 320, and transmits the found sub-category list to the display unit 330.

If the user selects a category from the second screen 420, i.e. the sub-category screen, the controller 340 transmits information on an updated category list screen, in which information on the selected sub-category is displayed in a field connected to the selected category, to the display unit 330.

If the user selects a piece of content from the fourth screen 440, i.e. the content list screen, the controller 340 can perform a function of reproducing or recording the content selected by the user, reserving the reproduction of the content selected by the user, or registering the content selected by the user in a playlist.

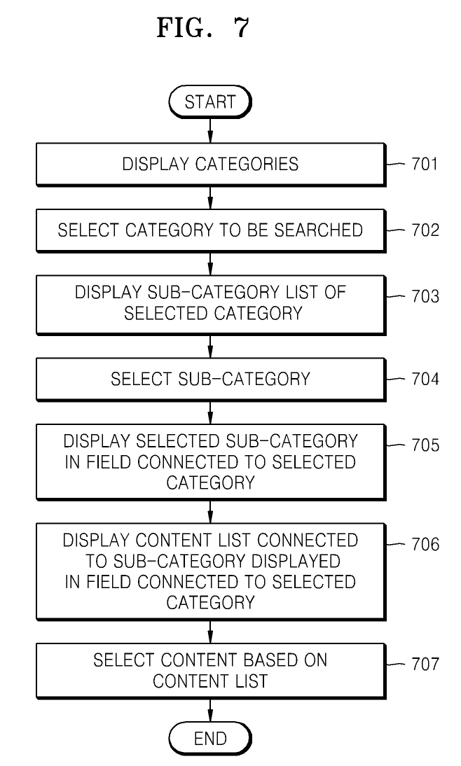

FIG. 7 is a flowchart of a content search method according to an exemplary embodiment of the present invention.

Referring to FIG. 7, in order to search for content, at least one user selectable category is displayed in operation 701. The displayed categories are similar to the categories displayed by the first screen 410 illustrated in FIG. 4.

A category to be searched is selected from among the displayed categories in operation 702, and a sub-category list of the selected category is displayed in operation 703. The displayed sub-category list is similar to the sub-category list displayed by the second screen 420 illustrated in FIG. 4.

A sub-category to be searched is selected based on the displayed sub-category list in operation 704. In operation 705, the selected sub-category is displayed in a field connected to the category selected in operation 702. Then, a screen similar to the third screen 430 illustrated in FIG. 4 is displayed. Information, such as a name of the selected sub-category, an abbreviation representing the selected sub-category, or an identification sign of the selected sub-category, may be displayed in the field connected to the selected category.

A content list connected to the sub-category displayed in the field connected to the selected category is displayed in operation 706. This operation may be performed by controlling the OK button 413 illustrated in FIG. 4, or performed without the OK button 413. Thus, a screen similar to the fourth screen 440 illustrated in FIG. 4 is displayed. A desired content is selected based on the displayed content list in operation 707. Thereafter, the current exemplary embodiment may further include at least one of an operation of reproducing the selected content, an operation of recording the selected content, an operation of registering the selected content in a playlist, and an operation of reserving the reproduction of the selected content. The screen for displaying the at least one category in operation 701, the screen for displaying the content list in operation 706, and the screen for displaying the sub-category list in operation 703 are different from each other.

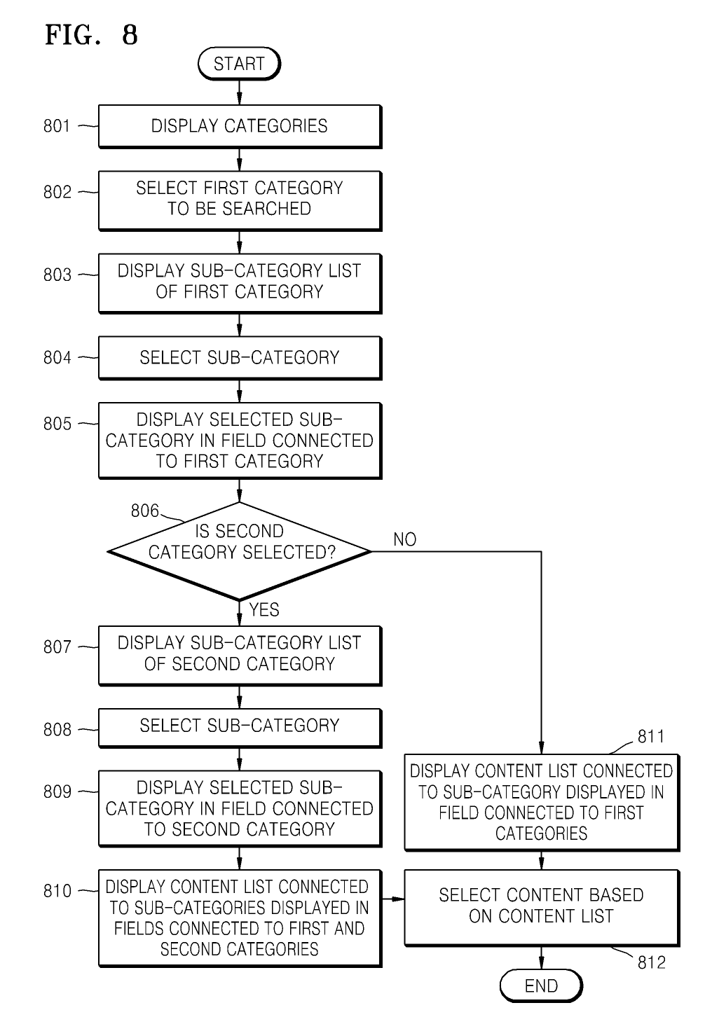

FIG. 8 is a flowchart of a content search method according to another exemplary embodiment of the present invention. FIG. 8 illustrates a case where a plurality of categories are selected. Since operations 801 through 805 illustrated in FIG. 8 are respectively similar to operations 701 through 705 illustrated in FIG. 7, detailed descriptions thereof are omitted here. However, since the plurality of categories are selected in FIG. 8, the category of FIG. 7 is defined as a first category. Thus, if operation 805 is performed, a screen similar to the updated category list screen 603 illustrated in FIG. 6 is displayed.

If a second category to be searched is selected in operation 806, a sub-category list of the second category is displayed in operation 807. The sub-category list of the second category is connected to a sub-category displayed in a field connected to the first category. Thus, a screen similar to the sub-category list screen 604 illustrated in FIG. 6 is displayed. A sub-category to be searched is selected based on the displayed sub-category list in operation 808. The selected sub-category is displayed in a field connected to the second category in operation 809. Then, a screen similar to the updated category list screen 605 illustrated in FIG. 6 is displayed.

A content list connected to the sub-categories displayed in the fields connected to the first and second categories is displayed in operation 810. This operation may be performed by controlling the OK button 613 illustrated in FIG. 6, or performed without the OK button 613. Thus, a screen similar to the content list screen 606 illustrated in FIG. 6 is displayed.

A desired content is selected based on the displayed content list in operation 812. The selected content may be processed as illustrated in FIG.

If the second category to be searched is not selected in operation 806, operations 811 and 812, respectively similar to operations 706 and 707 illustrated in FIG. 7, are performed.

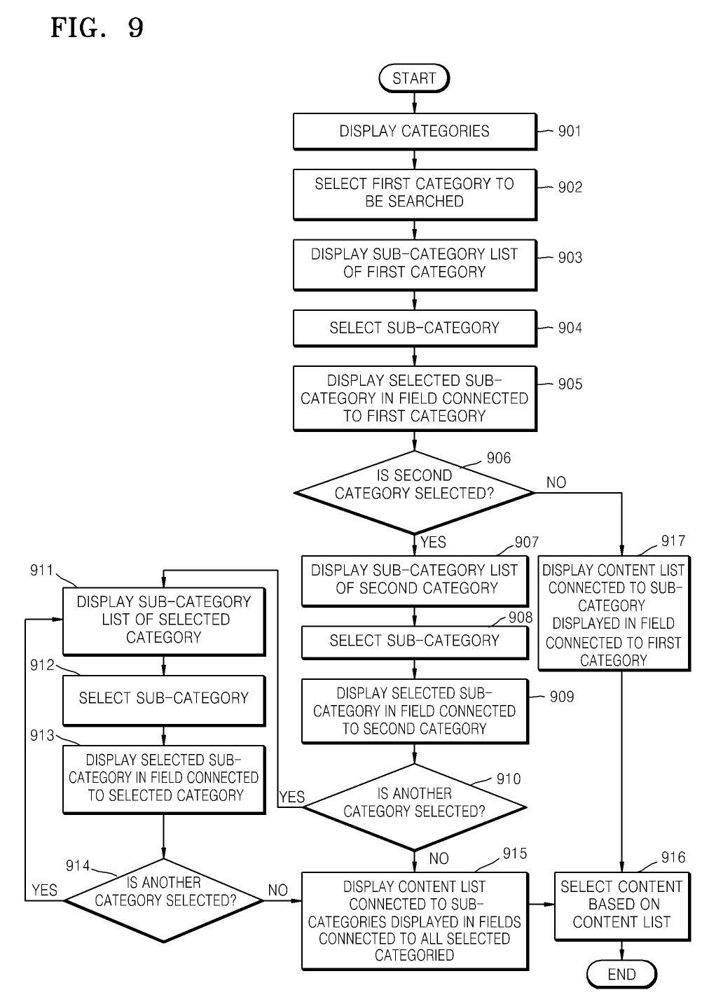

FIG. 9 is a flowchart of a content search method according to another exemplary embodiment of the present invention. FIG. 9 illustrates a case where three or more categories are selected. Since operations 901 through 909 illustrated in FIG. 9 are respectively similar to operations 801 through 809 illustrated in FIG. 8, detailed descriptions thereof are omitted here.

When a plurality of categories including a first category and a second category are displayed, in a state where sub-categories connected to fields respectively connected to the first category and the second category are displayed, if another category is selected in operation 910, a sub-category list of the selected category is displayed in operation 911.

A sub-category is selected based on the displayed sub-category list in operation 912. The sub-category selected in operation 912 is displayed in a field connected to the selected category in operation 913.

If another category is selected again in operation 914, operations 911 through 913 are repeated. However, if another category is not selected in operation 914, a process similar to operation 810 illustrated in FIG. 8 is performed in operation 915. A content list displayed in operation 915 is connected to sub-categories displayed in fields connected to all the selected categories.

If another category is not selected in operation 910, operations 915 and 916, respectively similar to operations 810 and 812 illustrated in FIG. 8, are performed. If the second category is not selected in operation 906, operations 917 and 916, respectively similar to operations 811 and 812 illustrated in FIG. 8, are performed.

The content search methods illustrated in FIGS. 7 through 9 may further comprise a process of returning to a process of displaying an immediately previous sub-category in a field, if a change to a screen for displaying at least one category is requested in a state where a content list or a sub-category list is displayed.

The present invention can also be embodied as computer readable codes on a computer readable recording medium. The computer readable recording medium is any data storage device that can store data which can be thereafter read by a computer system. Examples of the computer readable recording medium include read-only memory (ROM), RAM, CD-ROMs, magnetic tapes, floppy disks, and optical data storage devices. The computer readable recording medium can also be distributed over network coupled computer systems so that the computer readable code is stored and executed in a distributed fashion.

As described above, according to exemplary embodiments of the present invention, by displaying entire search conditions or entire metadata based categories of selected content on a single screen, a user can easily perceive the entire search conditions of the selected content.

In addition, by granting independent selection rights to metadata based categories available for content search, content can be searched for in a search order desired by the user, and thus, desired content can be found more quickly.

That is, for example, desired content can be found by searching for the content in an order of selecting “artist name” after accessing an “artist” category and selecting “album name” connected to the selected “artist name” by accessing an “album” category at a first time, and in another order of selecting “album name” after accessing the “album” category and selecting “artist name” connected to the selected “album name” by accessing the “artist” category at a second time. As described above, since the user can determine a desired search order, the desired content can be found more quickly.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of searching for content using metadata based categories, the method comprising:
displaying at least one category;
displaying a sub-category list of a first category selected from among the displayed categories;
displaying a sub-category, which is selected based on the sub-category list of the first category, in a field connected to the first category; and
displaying a content list connected to the sub-category displayed in the field.

2. The method of claim 1, further comprising:
displaying a sub-category list of a second category, if the second category is selected after displaying the sub-category in the field connected to the first category; and
displaying a sub-category, which is selected based on the sub-category list of the second category, in a field connected to the second category,
wherein the displaying the content list connected to the sub-category comprises displaying a content list connected to the sub-categories displayed in the fields connected to the first category and the second category.

3. The method of claim 2, wherein the sub-category list of the second category is connected to the sub-category displayed in the field connected to the first category.

4. The method of claim 1, wherein one of a name of the sub-category, an abbreviation representing the sub-category, and an identification sign of the sub-category is displayed in the field.

5. The method of claim 1, wherein a screen for displaying the at least one category has a different format from a screen for displaying the content list or the sub-category list.

6. The method of claim 1, further comprising at least one of processes of reproduction, recording, registration in a playlist, and reproduction reservation of content selected based on the content list.

7. The method of claim 1, further comprising returning to the displaying the sub-category in the field, if a change to a screen for displaying the at least one category is requested in a state where the content list or the sub-category list is displayed.

8. The method of claim 2, further comprising:
when a plurality of categories comprise the first category and the second category in the displaying the at least one category, if another category is selected in a state where the sub-categories are respectively displayed in the fields connected to the first category and the second category, sequentially displaying a sub-category list of the selected category and displaying a sub-category, which is selected based on the sub-category list of the selected category, in a field connected to the selected category,
wherein the displaying the content list connected to the sub-category comprises displaying a content list connected to the sub-categories displayed in the fields connected to all the selected categories.

9. An apparatus for searching for content using metadata based categories, the apparatus comprising:
an information input unit through which a user inputs information;
a display unit which displays a selectable category list, a sub-category list of a selected category, a category list updated by a sub-category selected based on the sub-category list, and a content list based on the updated category list;
a storage unit which stores at least one piece of content, metadata of the content, and metadata based category information of the content; and
a controller which transmits screen information for a content search to the display unit by searching the storage unit according to the information input via the information input unit.

10. The apparatus of claim 9, wherein the selectable category list and the updated category list comprise fields connected to corresponding categories, and each of the fields is an area in which information on the sub-category is displayed.

11. The apparatus of claim 10, wherein the field is defined in a User Interface pattern for representing a connection relationship between the category and the sub-category.

12. The apparatus of claim 10, wherein the information on the sub-category is one of a name of the sub-category, an abbreviation representing the sub-category, and an identification sign of the sub-category.

13. The apparatus of claim 9, wherein, if a change to the selectable category list is requested from the information input unit in a state where the content list or the sub-category list is displayed by the display unit, the controller changes a screen to an immediately previous category list screen.

14. The apparatus of claim 9, wherein, if a plurality of categories are selected from the selectable category list, sub-category lists of the plurality of categories are connected to each other, and the content list is a list of content connected to all sub-categories selected from the plurality of categories.

15. The apparatus of claim 9, wherein the metadata based category information of the content comprises the selectable category list, the sub-category list, and the content list, and the selectable category list is based on categories having independent selection rights.

16. The apparatus of claim 9, wherein a screen for displaying the selectable category list or the updated category list has a different format from a screen for displaying the sub-category list or the content list.

17. The apparatus of claim 9, wherein, if content is selected based on the content list, the controller controls one of a function of reproducing the content, a function of recording the content, a function of registering the content in a playlist, and a function of reserving a reproduction of the content.

18. A computer readable recording medium storing a computer program for executing a method of searching for content using metadata based categories, the method comprising:
displaying at least one category;
displaying a sub-category list of a first category selected from among the displayed categories;
displaying a sub-category, which is selected based on the sub-category list of the first category, in a field connected to the first category; and
displaying a content list connected to the sub-category displayed in the field.
